(19) United States
(12) Patent Application Publication
(10) Pub. No.: US 2010/0238119 A1
(43) Pub. Date: Sep. 23, 2010

(54) Touchscreen Keyboard Overlay

(76) Inventors: Zivthan Dubrovsky, Lexington, MA (US); Leslie Earle Dellinger, Acton, MA (US); Clark William Martin, Acton, MA (US)

Correspondence Address: Lawrence A. Aaronson, P.C.;Lawrence A. Aaronson, 12850 Highway 9, Suite #600 PMB 338, Alpharetta, GA, 30004, US

(21) Appl. No.: 12/621,466

(22) Filed: Nov. 18, 2009

Related U.S. Application Data
(60) Provisional application No. 61/161,395, filed on Mar. 18, 2009.

(51) Int. Cl. G06F 3/02

(52) U.S. Cl. 345/169

(57) ABSTRACT

An external cover for a tablet smartphone with a flat touchscreen includes a rear clamshell formed of deformable plastic material that receives and surrounds the tablet, and a rim that resiliently clips the rear clamshell to the tablet. A hinge blister and intervening web forms a two degree of freedom hinge with a form-fitting front clamshell that can be freely lifted and dropped on the touchscreen but indexes to it, can be locked in place with a clip that readily engages and disengages from a docking port at the bottom of the tablet, and that is strengthened by an arch shaped rim. A planar sheet, formed of dielectric plastic, that covers the entirety of the flat touchscreen, is slightly suspended above to create an air gap, and is formed in a shape and thickness that substantially transmits the shape of a capacitive finger contact patch through the planar sheet to the touchscreen when the sheet is pushed down to the touchscreen. A keyboard may be formed in, on, or with the planar sheet in a location corresponding to the location of a virtual keyboard appearing on the touchscreen.

CROSS-REFERENCE TO RELATED APPLICATIONS

This application claims priority to, and incorporates herein by reference the entirety of the disclosure of, U.S. Provisional Patent Application No. 61/161,395, entitled “Touchscreen Phone Keyboard Overlay with Key Response”, filed Mar. 18, 2009, EFS ID 4994121.

### BACKGROUND

On Mar. 17, 2009, Apple Computer announced iPhone OS 3.0, an operating system for the iPhone smartphone. Among various enhancements to the previous operating system was the new availability of a large, landscape-orientation touch keyboard (capacitive touchscreen with virtual keyboard) to certain applications (see the last Figure of this application).

A virtual keyboard had previously only been available to the phone's Internet browser, to fill in short fields and URLs and the like. The landscape orientation of this virtual keyboard and availability to other applications (Email, notes) is likely to be more useful for typing lengthy text passages (such as emails), but still has the basic weakness of a consumer or media oriented touchscreen phone—no tactile or haptic feedback, which creates errors in typing. Touch typing and rapid typing based on learned motor skills is not as fast as on, for example, a “Blackberry” or any of a host of phones with built-in mechanical keyboard panels.

Putting a slide or fold out or flip out keyboard panel in a monolithic tablet phone such as an iPhone would change the product class from primarily touchscreen interaction, and could adversely affect the reliability, industrial design, convenience, and user interface model. The primary mode of user interaction of touchscreen graphical user interface elements could readily be confused by a second input device in the form of a traditional flip out or slide mechanical keyboard. The mechanical and electrical elements of the keyboard make the phone larger, heavier, more complicated, more likely to require repair. No longer slim, sleek, or perceived to be light, no longer with a holistic user interface model where there is one consistent way to interact with the operating system, graphical user interface, and core applications, with a keyboard mechanism the elegant touchscreen “iPhone” would be just another phone festooned with confusing buttons and controls.

One market approach to fixing this shortcoming of the flat panel touchscreen phone—no feedback or control for typing—was to introduce haptic feedback, but in another inadequate way, which was abandoned by late 2009. With the Blackberry™ Storm™, preceding iPhone's OS 3.0 by several months, the entire touchscreen panel is the key pressed (once central sensor), so it moves and clicks with each virtual key pressed. A problem is that there is no way to start pressing one key before the previous key is released (since they are effectively the same key). Each “key” is pressed serially while one waits for the entire screen to return from the previous press. This constitutes haptic feedback, but slow.

Earlier in the history of the touchscreen phone, Sony Corporation had experimented with various phones that would permit a rigid panel to cover part of a touchscreen during phone use, to be flipped off or away for stylus based access to the touchscreen or even for typing on the flipped cover. Variations include a one or two sided keyboard panel (P800, P900 each one sided, P910i two). These panels were mechanically integrated and sometimes electronically wired into the phone and in some cases may have had pass through buttons to press on the panel.

This generally was a failed concept—the lines of the phone cannot be maintained, the orientation doesn't permit reliable thumb typing on a full QWERTY keyboard, the user interface changes changing with the flip down or up or stylus use. The buttons are not believed to be pass-through, but simply on the flip rigid panel and connected via the hinge.

Pre-OS 3.0, in mid 2008, a keyboard panel called “my touch keys” made a brief appearance in the market. This panel was a single sheet overlay with complete through-holes where one instantiation of the virtual keyboard appeared.

This panel permitted use of the capacitive touchscreen and included pass-through holes only for a portrait mode keyboard. It was affixed by adhesive or static, could not be stowed, and the mechanism for tactile feedback is merely holes that guide the fingers to the positions of the keys on the virtual keyboard. There is tactile feedback in a broad sense but no key response in a traditional sense. This is a feedback mechanism that has to be newly learned.

Moreover, this panel was provided only for the small portrait mode keyboard. Before the iPhone OS 3.0 software revision was introduced, the virtual landscape keyboard was available only for entering URLs, and not available to the most useful applications (prose applications like note taking, email), and generally could not be used for typing prose.

### SUMMARY

One aspect of the present invention, is an external cover for a monolithic tablet smartphone formed as a smoothed tablet with a flat touchscreen on a front surface thereof and a docking port at a bottom portion of a rounded peripheral side wall of the smoothed tablet.

The cover includes a rear clamshell formed of deformable plastic material that receives and surrounds a rear surface and a portion of a peripheral side wall of the smoothed tablet. This rear clamshell includes a form-fitting rear surface that matches the shape of the rear of the rounded tablet. A rim extends about the periphery of the form fitting rear surface to a height greater than ½ of the height of the peripheral side wall. In this manner, the rear clamshell can deform and resiliently clip the rear clamshell to the smoothed tablet. A hinge blister located at the top of the rear surface includes a first hinge mechanism having a first degree of freedom.

The shape of the rim more than half of the curved side wall permits the rear clamshell to flex enough to clip over/into the rounded edges of the side of the tablet smartphone and be held by the curve. The blister hinge, which separates the first axis from the clamshell itself, is the first part of a mechanism that permits the front clamshell to not only close to the front surface of the touchscreen, but to form an U-frame shape that holds the phone an its screen vertical or horizontal with respect to a flat surface (e.g., for use as an unheld viewing screen).

The cover also includes the front clamshell that receives and surrounds the front surface of the smoothed tablet. The front clam shell also has a rim, but in this case a form fitting front rim portion that matches the shape of a front portion of the peripheral side wall, to a height less than ½ of the height of the peripheral side wall, to be freely lifted and dropped on the front surface of the smoothed tablet but indexed to it as the front rim portion engages the entire upper side wall near the front surface. The front clam shell does not clip or snap to the tablet smartphone.

To provide structural strength in ordinary use, the form fitting front rim extends into or joins an arch shaped rim portion extending from the form fitting front rim portion. An arch shaped cross section extends about substantially the periphery of the front clamshell, giving the front clamshell structural strength and helping the front clamshell resist twisting and other deformations. The rear clamshell, on the other hand, resists such deformation by closely conforming to the rear of the tablet smartphone.

The front clamshell includes a planar sheet, formed of dielectric plastic (e.g., transparent or smoked polycarbonate), that covers the entirety of the flat touchscreen and is joined to the arch shaped rim portion (again, helping maintain stiffness and shape). The planar sheet is formed in a shape and thickness that substantially transmits the shape of a capacitive finger contact patch through the planar sheet to the touchscreen. This can be a simple sheet of appropriate thickness, but can also form a molded prose keyboard, a movable prose keyboard, or another kind of molded or moving physical user interface such as a guide, clicker, wheel, rocker, or the like. “Prose” keyboard as used herein indicates a QWERTY or other keyboard capable of typing individual letters in a single press, by and large actual QWERTY keyboards, international variations such as AZERTY and Asian IME keyboards, and thereby capable of reasonably composing prose passages—this excludes typical telephone text messaging and predictive keyboard strategies such as “T9”.

One kind of molded prose keyboard includes key target forms in the shape of channels or troughs. The bottom of the trough transmits a finger capacitive contact patch, and the walls of the trough attenuates the finger contact patch at the edge (which discourages missing the virtual key intended and activating the neighboring virtual key).

One kind of mechanical prose keyboard includes key target forms in the shape of keyboard keys. In this case, the keys can be mounted resiliently or with other travel mechanism, and an air gap can provide the attenuation at the edge of the contact patch. Optionally, a clicking mechanism or snap dome may be part of the stack assembly from front planar sheet to touchscreen. Generally, a keyboard of minimum planar thickness may be suspended above the touch screen so that there is both some travel of the keyboard (mostly due to flexing). An additional benefit is that dragging a finger lightly over key borders, barriers, or walls doesn't give a false capacitive triggeer. Some light pressing is needed to close the air gap, which provides some tactile response.

The inclusion of a prose keyboard form renders the device highly specialized, and a landscape device would not permit portrait mode prose typing (although a second front clamshell or cover could be switched in). A portrait mode device would have its prose keyboard and window arranged for the portrait mode prose keyboard, but would also be hinged and lockable with respect to the sides discussed above (e.g., supported from and lockable along long sides of the phone).

The front clamshell has a locking clip formed at a bottom portion of the second rim portion proximate the location of the docking port, that engages with a cavity in the docking port and is deformable to disengage the front clamshell from the smoothed tablet. The locking clip may alternatively have a locking hinge mechanism, or engage a cavity or other engaging member formed in the rear clamshell.

At the top of the front claim shell, a second hinge mechanism having a second degree of freedom is located. A substantially rigid linking member that forms a reversible wrapping linkage by connecting the first and second hinged mechanisms. Wrapping, in this context, indicates that the front clam shell can be wrapped or swung parallel to the front as well as to the back of the body of the tablet smartphone, which, as noted, lets the external cover act as a stand.

In the case of a capacitive multitouch panel (not that touchpanels discussed herein generally include an LCD, OLED, e-ink or other such display), even though a virtual keyboard may not be designed to be used by holding two keys at once, providing the virtual keyboard can mean a user can more easily hold SHIFT while typing to capitalize letters, thus making for more natural typing.

These examples form a prose keyboard, and are useful in landscape mode, flip to the back of the phone, actuate a multitouch capacitive panel, permit viewing a virtual prose keyboard therethrough or replicate the virtual keyboard.

### BRIEF DESCRIPTION OF THE DRAWINGS

FIG. 1 is an exploded view of one embodiment of the present invention, as it attaches to a tablet shaped smartphone.

FIG. 2A is a perspective view of one embodiment of the present invention, as attached to a tablet shaped smartphone, in an open position.

FIG. 2B is a perspective view of one embodiment of the present invention, as attached to a tablet shaped smartphone, in a closed position.

FIG. 3A is a cross sectional view of one embodiment of the present invention, along line R-R of FIG. 2B.

FIG. 3B is a magnified cross sectional view of a rim and arch shape shown in FIG. 3C, along line S-S of FIG. 2B.

FIG. 3C is a cross sectional view of one embodiment of the present invention, along line S-S of FIG. 2B.

FIG. 4 is a set of orthogonal views of one embodiment of the present invention, showing top, front, side, rear, and bottom sides.

FIGS. 5A-5C are a perspective views of a hinge member or web of one embodiment of the present invention.

FIG. 6 is a side view of one embodiment of the present invention, in a portrait display “stand” mode.

FIG. 7A is a perspective view of one embodiment of the present invention, in a portrait display “stand” mode.

FIG. 7B is a perspective view of one embodiment of the present invention, in a landscape display “stand” mode.

FIGS. 8A-8G is a series of side schematic views of one embodiment of the present invention, transitioning from open to closed positions, including the A-frame or U-frame position for portrait or landscape “stand” mode.

FIGS. 9A-9D is a series of side schematic views showing various keyboard techniques for localizing a user's finger more accurately.

FIGS. 10A-10D show alternative overlays for virtual input interface elements, including a prose keyboard, a calculator keyboard, a handheld game console input panel, and one common MP3player input panel.

### DETAILED DESCRIPTION OF THE EMBODIMENTS

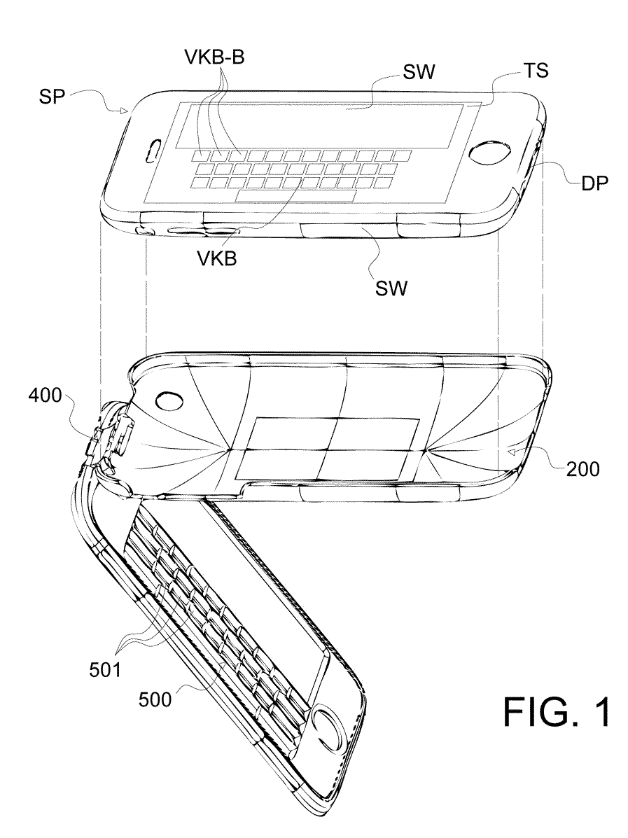

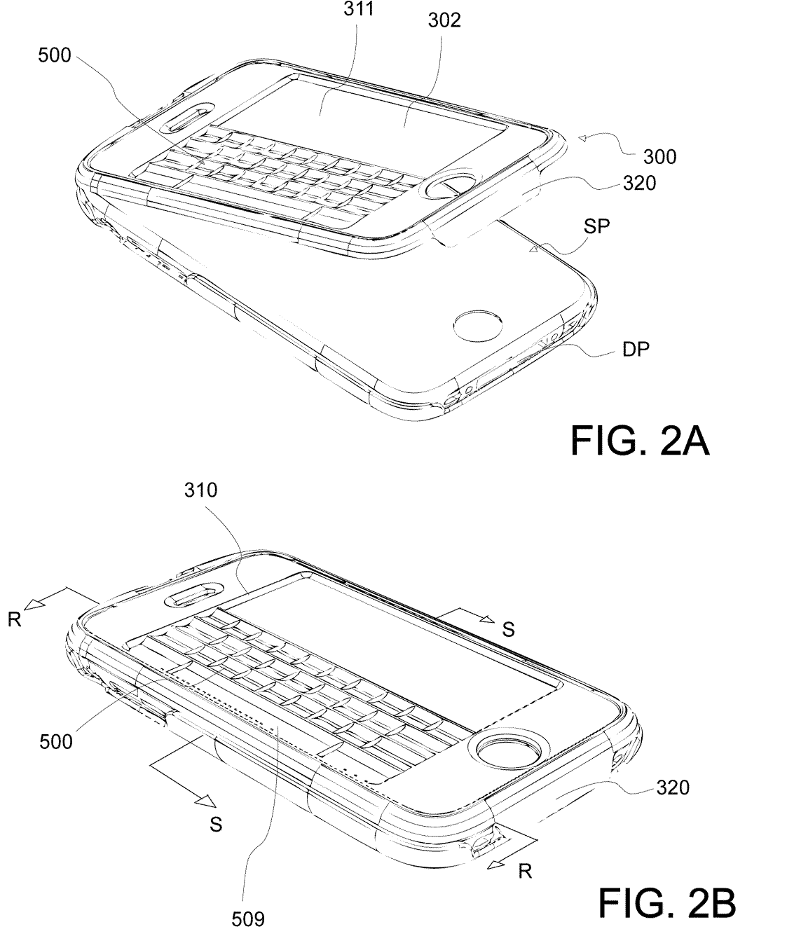

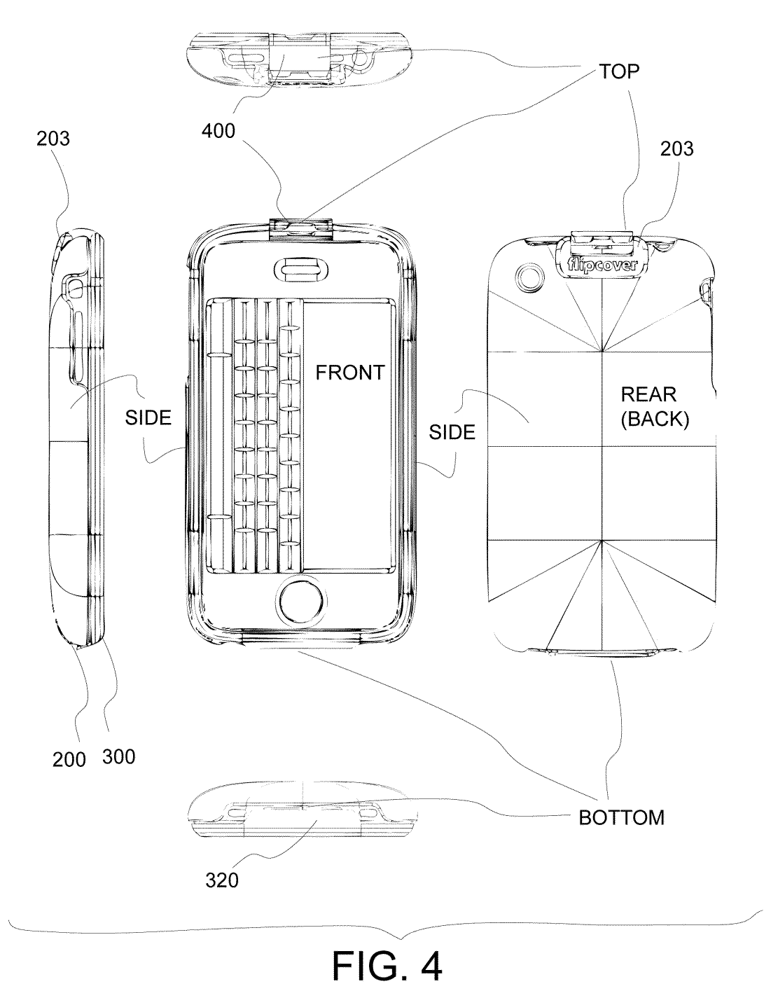

FIG. 1 is an exploded view of an embodiment of a touchscreen (virtual) keyboard overlay 100 of the present invention, as it attaches to a tablet shaped smartphone. FIG. 2A is a perspective view of the touchscreen (virtual) keyboard overlay 100 of the present invention, as attached to a tablet shaped smartphone SP, in an open position after being inserted. FIG. 2B is a perspective view a touchscreen (virtual) keyboard overlay 100 of the present invention, as attached to a tablet shaped smartphone SP, in a closed position, as snapped shut. FIG. 4 provides reference for top, front, rear, side (back) and bottom sides discussed herein (which are considered the same for the smartphone SP and the overlay device 100.

As shown in FIG. 1, the smartphone SP may be clipped into the touchscreen (virtual) keyboard overlay 100 (alternatively, adhered by a pad at the bottom of the overlay's lower clamshell). Referring to FIG. 1, in the context of a monolithic tablet shaped smartphone SP including no mechanical QWERTY keyboard of any kind—no slide out, no flip open, no fold out, no “candy bar” keyboard—the present embodiment and its variations can be described as a flexible or partially flexible keyboard panel 300, made of sufficient amounts of elastomer or with sufficient flexibility or hinges 400, to (1) flatten to and partially cover the portion of a capacitive touchscreen TS, particularly an iPhone™ style multitouch capacitive touchscreen TS, in the portion where a landscape keyboard VKB appears when typing applications are in use and (2) flexibly or via hinges flip away all the way to the opposite side of the phone SP, where it integrates with the form and lines of a casing, housing, sleeve, jacket 200 used to house the phone and support the hinge 400 and via that, the keyboard panel 300. A front clamshell 300 may, in the same manner, flip away all the way to the opposite side of the phone SP, where it cooperates with the form of the rear clamshell 200 used to house the phone SP and support the hinge 400 and via that, the keyboard panel 300.

The panel 300 is transparent and does not obscure the subwindow SW of the embedded UI—i.e., the typing area where letters appear VKB. In the prose entry mode, the screen is broken into a keyboard area with the virtual keyboard VKB and a subwindow SW that has a smaller graphical display (i.e., the prose entry mode breaks the display area into a text input area and a smaller display window). The panel includes button elements or key target forms 301 that (1) when the panel is flattened in a mounted position on the touchscreen side, cover each button VKB-B and approximate the shape of each button VKB-B in the on-screen virtual keyboard VKB (in some cases, more than one on-screen virtual keyboard) (2) are or may be sufficiently raised from the surface to permit key travel in the manner of membrane keyboards, preferably with air space between the button and the touchscreen TS (3) are or may be biased up by elastomer around the button rim to return after travelling down when pressed (4) are or may be substantially transparent to permit the button identity to be viewed therethrough (5) have or may have sufficient conductive material therein, either as a pass-through molded element or as conductive or capacitive plastic, to permit finger actuation of the button to inherently activate the corresponding area on the capacitive touch panel TS. In the case of a mechanical version with key travel, when one presses the button 301, it does not actuate the virtual keyboard button until there is a tactile press and travel down to the touchscreen TS. The electrical connection, conductance, or capacitance from a finger via the button to the touchscreen TS activates the coordinates on the touchscreen panel TS (filtered to recognize a finger contact patch) and thereby the virtual keyboard button VKB-B underneath.

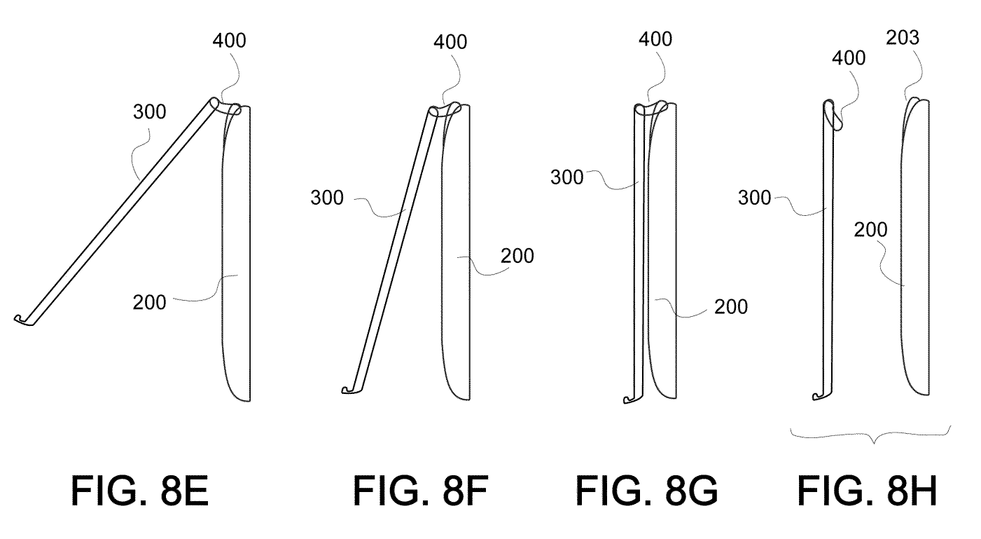

A wrapping, unwrapping, and rewrapping in the opposite direction is ideal, as opposed to hinging a rigid panel. Double hinging a rigid panel is also preferred. Peeling a banana or a candy bar is the motion to be emulated. Silicone is known as a phone protecting cover, and would also provide the appropriate elastomer properties for elevated membrane key buttons. Doping, embedding, or double-molding of carbon, graphite, or other conductive material in the button regions may makes an electrical connection between finger and keyboard. In addition, transparent materials with correct electrical properties are known, acrylic or electrostatic membrane, some rigid. In other words, when the keyboard panel is wrapped to the touchscreen side (see FIG. 8, position P1), raised buttons with tactile feedback can be typed on; when the keyboard is wrapped to the non-touchscreen side (see FIG. 8, position P7), the phone's touchscreen is as it was without the overlaid keyboard. Multitouch may be conducive to using shift keys or typing as fast as possible.

The external cover 100 for a monolithic tablet smartphone SP formed as a smoothed tablet with a flat touchscreen TS on a front surface thereof and a docking port DP at a bottom portion of a rounded peripheral side wall SW of the smoothed tablet.

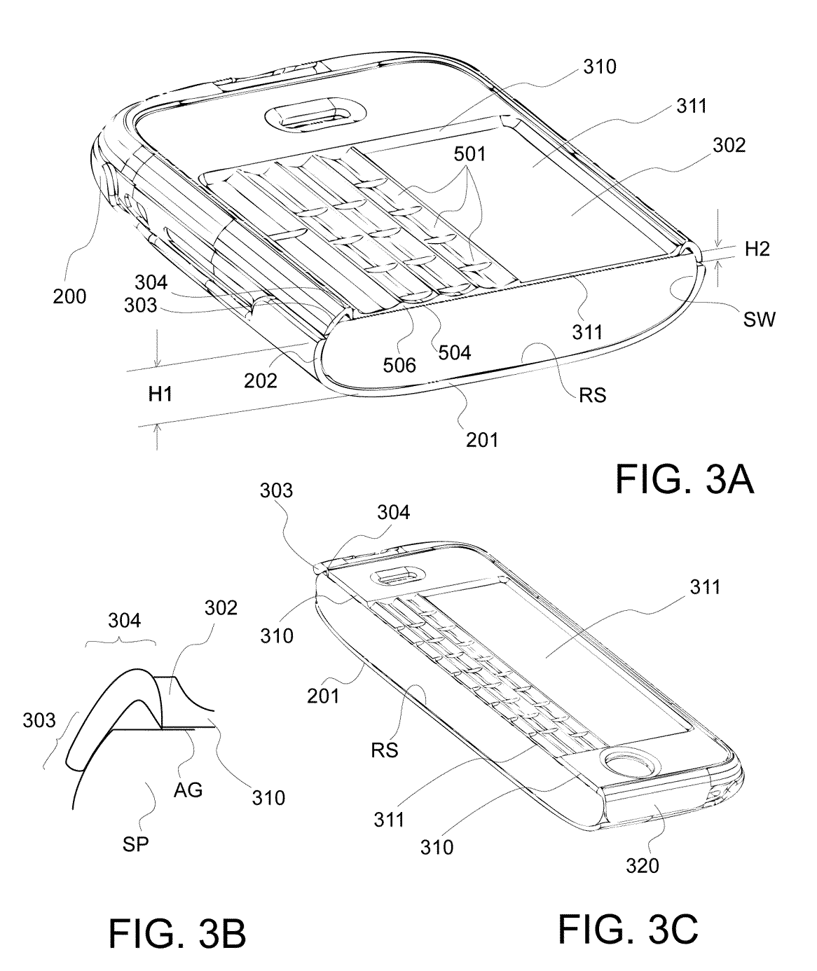

FIG. 3A is a cross sectional view of one embodiment of the present invention, along line

R-R of FIG. 2B. FIG. 3B is a magnified cross sectional view of a rim and arch shape shown in FIG. 3C, along line S-S of FIG. 2B. FIG. 3C is a cross sectional view of one embodiment of the present invention, along line S-S of FIG. 2B.

As further shown in FIGS. 3A-3C, the cover 100 includes a rear clamshell 200 formed of deformable plastic material that receives and surrounds a rear surface RS and a portion of a peripheral side wall SW of the smoothed tablet. This rear clamshell includes a form-fitting rear surface 201 that matches the shape of the rear RS of the rounded tablet. A rim 202 extends about the periphery of the form fitting rear surface 201 to a height H1 slightly greater than ½ of the height of the peripheral side wall SW. In this manner, the rear clamshell 200 can deform and resiliently clip the rear clamshell 200 to the smoothed tablet shape of the smartphone SP. A hinge blister 203 located at the top of the rear surface 201 includes a first hinge mechanism 204 having a first degree of freedom (in the form of, e.g., an elongated pin extending along the top edge, having sufficient surrounding clearance along the pin to permit a semi-closed cylindrical channel in a mating plastic web or member 400 to clip thereon and rotate through at least 160-270 degrees). In an alternative embodiment, the hinge blister 203 may be adhesively affixed directly to the body of the smartphone to support the front clamshell directly.

The shape of the rim 202, with a height H1 more than half of the curved side wall SW permits the rear clamshell 200 to flex enough to clip over/into the rounded edges of the side of the tablet smartphone SP and be held by the curve of the side wall SW. If the tablet is formed as a truncated oval, the height H1 that is ½ of the height of the side wall SW corresponds to half of an approximate radius of curvature of the side wall SW. In any case, the form-fitting rim 202 is of sufficient height H1 such the clipped-on rim 202 has a portion narrower than the maximum sidewall-to-sidewall width side to side of the smartphone PS.

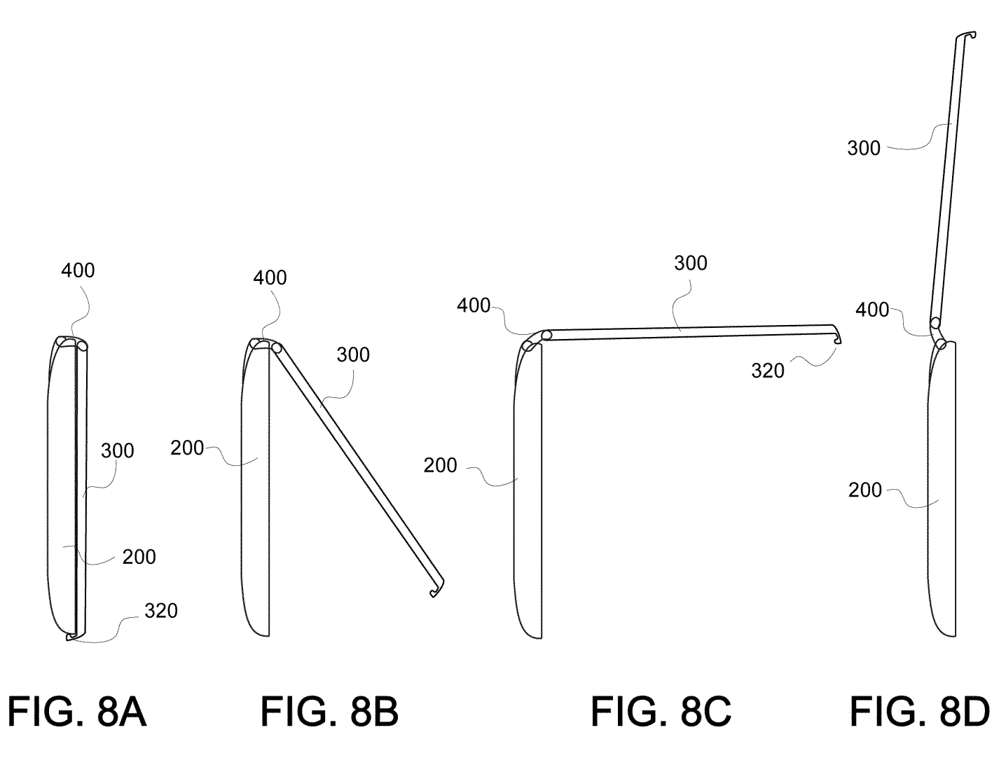

The blister hinge 203, which separates the first axis 220 of the double hinge 204-400-330 from the clamshell 200 itself, is the first part of a wrapping mechanism that permits the front clamshell 300 to not only close to the front surface of the touchscreen TS, but to wrap around and form an U-frame shape that holds the phone PS and its screen vertical (portrait) or horizontal (landscape) with respect to a flat surface (e.g., for use as an unheld viewing screen, see FIGS. 7A and 7B).

The cover 100 also includes the front clamshell 300 that receives and surrounds the front surface of the smoothed tablet. The front clam shell 300 also has a rim, but in this case a form fitting front rim 303 portion that matches the shape of a front portion of the peripheral side wall SW, to a height less than ½ of the height of the peripheral side wall SW, to be freely lifted and dropped on the front surface of the smoothed tablet but indexed to it as the front rim portion 303 engages the entire upper side wall SW near the front surface. The front clam shell 300 of this embodiment need not clip or snap “into” the tablet smartphone SP other than at the bottom clip (discussed below)

To provide structural strength in ordinary use, the form fitting front rim 303 extends into or joins an arch shaped rim portion 304 extending from the form fitting front rim portion 303. An arch shaped cross section 303 extends about substantially the periphery of the front clamshell 300, giving the front clamshell 300 structural strength and helping the front clamshell 300 resist twisting and other deformations. The rear clamshell 200, on the other hand, resists such deformation by closely conforming the entire wall 201-202 to the rear RS of the tablet smartphone SP.

The front clamshell 300 includes a planar sheet 302, formed of dielectric plastic (e.g., transparent or smoked polycarbonate), that covers the entirety of the flat touchscreen TS (optionally, and as shown, the entirety of the front of the smartphone PS) and is joined to the arch shaped rim portion 303 (again, helping maintain stiffness and shape). The planar sheet 302, in the portion covering the touchscreen TS, is formed in a shape and thickness that substantially transmits the shape of a capacitive finger contact patch through the planar sheet 302 to the touchscreen TS. The planar sheet 302 may include a thicker planar portion 310 (e.g., 1 mm to 2 mm thick) in areas of the front of the smartphone that have no capacitive sensing capability and a thinner planar portion 312 (e.g., ½ or 20/1000 inch thick) in areas that are capacitively responsive (as shown); it may include through-holes in the shape of pres sable buttons or other mechanical inputs; or to expose ports such as docking, interface, headphone; or to expose speaker and/or microphone (as shown). Note the rear clamshell portion 201 may also include such through holes (e.g., for a camera).

Modern capacitive panels may not need particular electrical characteristics to permit actuation, for example the panel detecting anything other than air contact as an appropriate change in capacitance indicating a potential touch. However, multitouch panels that can obtain a matrix of contact pixels at different locations include, in the phone's input software, filtering and interpreting routines to exclude all but “finger” contact patches, i.e., round or oval contact patches of the appropriate size and other distinctive characteristics. Accordingly, preserving the contact characteristics of the typical finger contact is necessary. In order to do this, the panel 302 can be a plastic sheet of appropriate thickness, but can also form a molded keyboard, a movable keyboard, or another kind of molded or moving physical user interface such as a guide, clicker, wheel, rocker, or the like.

One kind of molded keyboard 500 includes key target forms 501 in the shape of channels or troughs. The bottom of the trough 504 transmits a finger capacitive contact patch, and the walls 506 of the trough attenuates the finger contact patch at the edges of the key (which discourages missing the virtual key intended and activating the neighboring virtual key). In the case of a minimum thickness at the bottom of the trough 504 and a maximum thickness 506 away from the key center, the user's finger F is encouraged to create a contact patch in the middle of the corresponding virtual key, which mechanically discourages false signals, actuating the neighboring key, or actuating two keys at once.

One kind of mechanical keyboard 500 includes key target forms 501 in the shape of keyboard keys. In this case, the keys can be mounted resiliently or with other travel mechanism, and an air gap can provide the attenuation at the edge of the contact patch. Optionally, a clicking mechanism or snap dome may be part of the stack assembly from front planar sheet to touchscreen.

The front clamshell 300 has a locking clip 320 formed at a bottom portion of the second rim portion proximate the location of the docking port DP, that engages with a cavity in the docking port DP and is deformable to disengage the front clamshell 300 from the smoothed tablet. The locking clip 320 may alternatively have a locking hinge mechanism, or engage a cavity or other engaging member formed in the rear clamshell 200.

At the top of the front clam shell 300, a second hinge mechanism 330 having a second degree of freedom is located. A substantially rigid linking member 400 or web forms a reversible wrapping linkage by connecting the first and second hinged mechanisms 203, 330. Wrapping, in this context, indicates that the front clam shell 300 can be wrapped or swung parallel to the front as well as to the back of the body of the tablet smartphone SP, which, as noted, lets the external cover 100 act as a stand in both portrait and landscape orientations. In other words, the dual parallel hinges 203, 330 (alternatively one at the side and one at the phone edge) would permit a rigid web to bend around the front and back of the phone, forming an L (or U) shape in each direction, but in opposite ways.

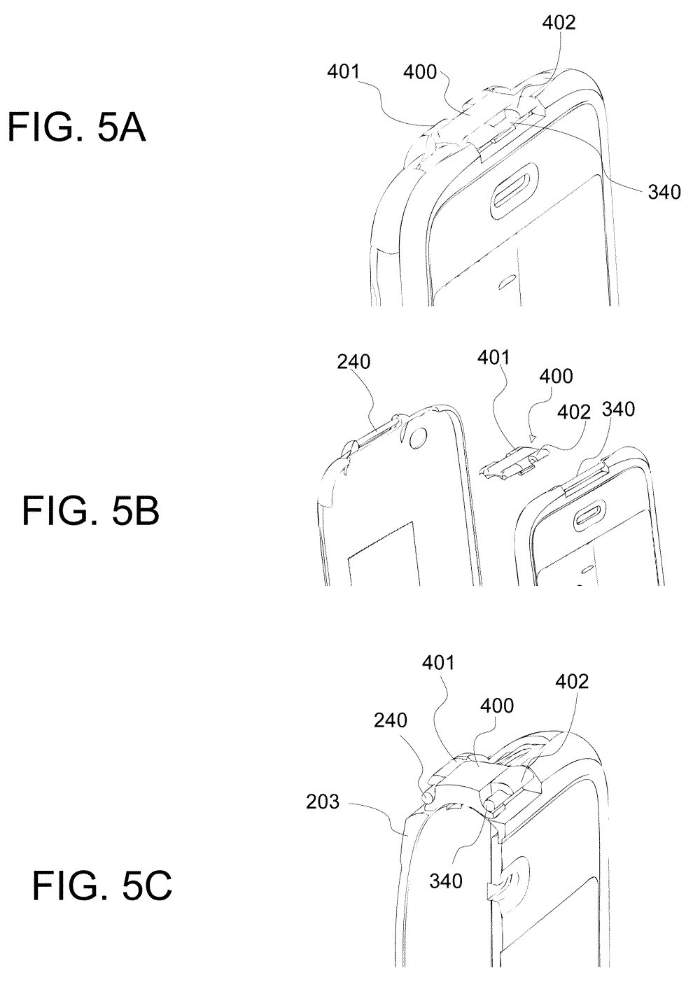

FIGS. 5A-5C are a perspective views of an example of such a hinge or web of one embodiment of the present invention. As shown in FIG. 5A, as connected, in FIG. 5B, exploded, and in FIG. 5C, in cross section, the linking member or web 400 connects a substantially c-shaped three finger channel 401 to a rear clamshell pin 240, and a similar C-shaped three finger channel 402 to a front clamshell pin 340. Each engaged pin and finger mechanism permits a full range of rotation; resists twisting; and can be snapped on and off at either end. The motions permitted by the resulting double hinge are shown and discussed below with reference to FIGS. 8A-8D.

It is helpful that the wrapping and unwrapping can be done with at least thumb and forefinger of one hand, else the obstacle to rapid, convenient use is likely bothersome and inelegant. Because it is a more natural motion to unlock a box or clamshell from the bottom using a hinge 203, 330 at the top, it would be better for this purpose to hinge 203, 330 the panel 300 at the top (top side of phone SP in image, right side of phone SP when the phone SP is in portrait orientation) and lock it at the bottom. Locking for a flexible or elastomeric clamshell may encompass wrapping twice or wrapping and clinging, if the adhesion or retention is sufficient to permit the keyboard to stay in place while typing.

It is would also be helpful that the unwrapped or stowed front clamshell 300 or panel (e.g., wrapped to or stowed on the non touchscreen TS side) smoothly integrates with the body of the rear clamshell 200 or smartphone SP. Hence, the housing that supports the panel 300 (e.g., the back clamshell 200) ideally has a form fitting receptacle in which the front panel 300 is docked, and the front panel 300 may be flexible enough to bend to fit within the receptacle. In the case of a front clamshell 300, the form fitting rim portion 303 may be elastomeric and wrap in an opposite direction, leaving the arch shaped rim 304 (or a tubular or metal wire rim) for structural strength. The invention is contemplated to include both ideal and preferred embodiments.

This is an “aftermarket’ addition to the basic phone SP. The examples discussed above may be modified to cover the entire touchscreen TS excepting the subwindow SW or area where text appears as it is typed. The window can be a hole, or a thinner region of plastic 311, changing materials in the window material or layering a more rigid material is a less desirable but alternative embodiment. As noted, a mechanism 320 for hasp or click-locking the panel to the face can be included (which could be wrapped around the side or top side). One example 320, noted above, engages with the depressions, cavities, pins, or other parts of the bottom docking mechanism DP. Other typical lock/connector/snap mechanisms would be, e.g., concentric cylindrical pill-box shaped interlocking depressions or protrusions (like on a coffee cup lid), simple flexible type hasps. Alternatively, if sufficient electrostatic or attractive charge or adhesive or clinging properties can be embedded in the panel material, the panel may lay against the touchscreen and adhere there in the same manner as static or clinging plastic films using plasticizers. Not a particularly large amount of resistance to shear or displacement is needed; the manner of adhesion cannot disrupt the capacitive multitouch.

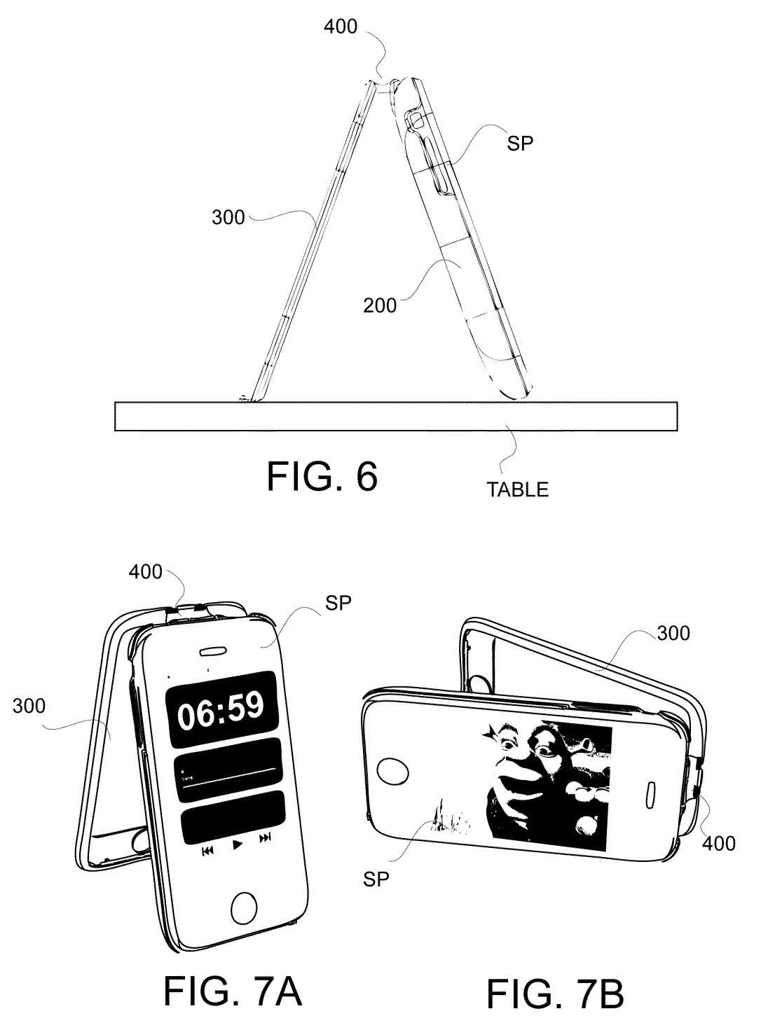

As shown in FIG. 6, the hinge mechanism including the web 400 permits the assembled overlay device 100 and smartphone SP to be used as an A-Frame or U-Frame smartphone stand for passive, non-keyboarding activities. As shown in FIG. 7A, this is effective in a portrait orientation (e.g., at bedside as an alarm clock, as a hands-free telephone). As shown in FIG. 7B, this is also effective in a landscape orientation (e.g., to show TV shows or movies).

FIGS. 8A-8H show differing stages of clamshell use. FIG. 8A shows the front clamshell 300 clipped to the rear clamshell 200 via the clip 320 engaging the docking port DP (alternatively the rear clamshell 200, exposing the entirety of the docking port DP). FIG. 8B through 8G show transitional positions as the front clamshell 300 is unclipped, lifted overtop of the rear clamshell 200, positioned behind the rear clamshell 300 (including the position useful as a display stand in portrait and landscape orientations) and finally the front clamshell 300 is roughly parallel to the rear clamshell 200 on the rear side of the smartphone SP. FIG. 8D depicts the front clamshell 200 and hinge member 400 unclipped from the hinge blister 203, such that the rear clamshell itself 200 becomes a standalone rear cover; and such that the user may exchange different front clamshells 300. As discussed herein, the combination or kit of a common rear clamshell 200, a first front clamshell 300 having a completely flat, capacitive pass-through planar front transparent panel (no keyboard) readily clipped to the hinge of the rear clamshell, and a second front clamshell having a keyboard formed in, on, or with the clamshell that is also readily clipped to the same hinge is contemplated as an embodiment of the present invention.

After the keyboard panel or front clamshell 300 is locked in place over the touchpanel TS, typing is done in two hands with both thumbs, “blackberry™ style”, and use of the wrap or front clamshell 300 usually would be limited to particularly lengthy missives or an email session of answering several emails in a row. For this reason, the wrap or front clamshell 300 should take less than a second to secure in a stowed or use position.

The planar sheet 302 may be transparent polycarbonate of substantially 20/1000 minimum thickness.

One variation includes a landscape form keyboard shape 500 formed in the polycarbonate planar sheet 302, including key target forms 501 located in positions on the touchscreen TS substantially indexed individually to corresponding keys VKB-B of a virtual landscape keyboard VKB displayed on the touchscreen TS underneath the (e.g., polycarbonate) planar sheet 302, such that letter and symbol indicia of the keyboard VKB are displayed through the key target forms 501. Alternatively, the keyboard shape may be opaque, with each key's QWERTY letter embossed, silk screened, or otherwise indicated on or in the the key target forms.

At least one key target form 509 may be located in a positions on the touchscreen indexed to more than one corresponding key (e.g., .COM key or spacebar in different positions on an iPhone™) of more than one virtual landscape keyboard VKB displayable on the touchscreen TS underneath the planar sheet 302, such that a same key target form 509 extends across different letter and symbol indicia of different keyboards VKB displayable through the key target form 509.

As shown, the key target form 501 is an elongated channel-shaped cavity or trough, having a minimum thickness 504 substantially in the center thereof that substantially transmits the shape of a capacitive finger contact patch through the planar sheet 302 to the touchscreen TS, and walls 506 surrounding the minimum thickness that attenuate the edges of the shape of a capacitive contact patch through the planar sheet 302 to the touch screen TS.

Alternatively, the key target form may be a key shape having a minimum thickness substantially in the center thereof that substantially transmits the shape of a capacitive finger contact patch through the key shape, surrounded by a partial air gap that attenuate the edges of the shape of a capacitive contact patch through the planar sheet to the touch screen.

In this case, a snap dome mechanism may intervene between the key shape and substantially transmits the shape of a capacitive finger contact patch therethrough.

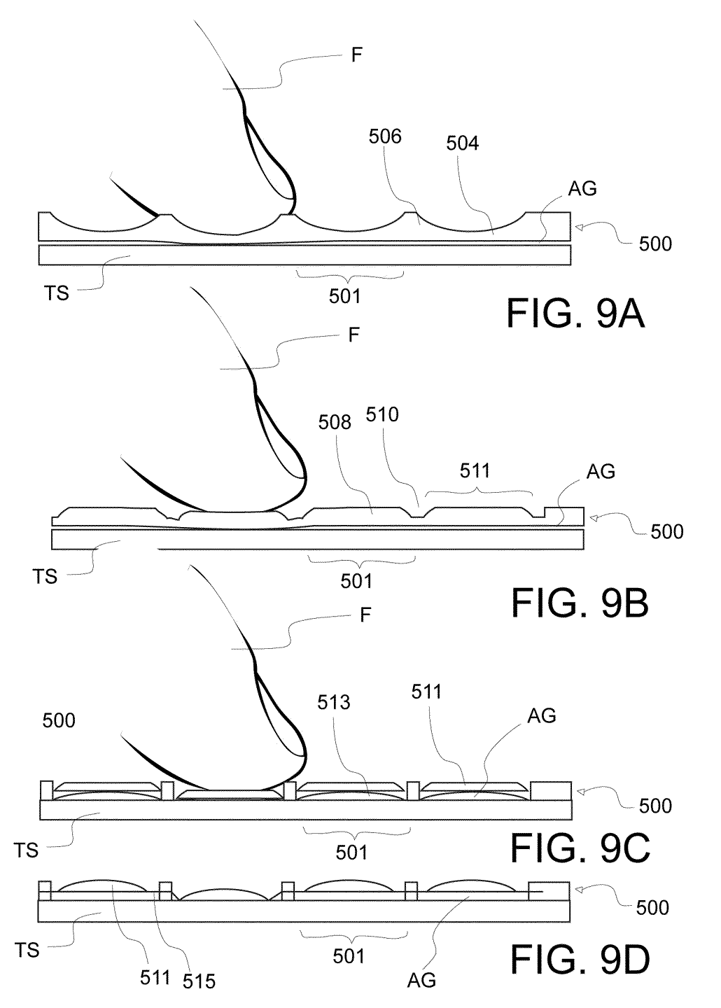

As shown in FIGS. 9A-9D, different techniques apply for substantially transmitting the shape of a capacitive finger contact patch, and, at the same time, improving the localizing of a user's finger to the center of the corresponding key location on the virtual keyboard VKB.

FIG. 9A shows the technique that is also shown in FIGS. 1-7. In this technique, each key target form 501 is an elongated channel-shaped cavity or trough, having a minimum thickness 504 (preferably in the ½ mm, 20/1000 inch range) substantially in the center thereof that substantially transmits the shape of a capacitive finger contact patch through the planar sheet 302 to the touchscreen TS, and walls 506 (preferably in the 1-2 mm range) surrounding the minimum thickness of that attenuate the edges of the shape of a capacitive contact patch through the planar sheet 302 to the touch screen TS. The user's finger F conforms to the shape of the trough, which may have a flattened bottom. The walls of the trough guide the user's finger F to the center of the corresponding virtual key VKB-B of the virtual keyboardSide to side, the key target forms may be separated by barrier walls (also 1-2 mm thick, but with more vertical walls, as show in the remaining Figures).

FIG. 9B shows an alternative technique. In this technique, each key target form 501 is a raised key cap 511, having a minimum thickness 508 (preferably in the ½ mm, 20/1000 inch range) substantially in the center thereof that substantially transmits the shape of a capacitive finger contact patch. Channels 510 separate the key caps 511 and encourage the air gaps 510 between the finger F and the keyboard 500. To the extent that it is difficult to mold plastic thinner than ½ mm, the key caps 501 may be adhered or thermoset to a thin sheet of film stock. The user's finger F tends to strike top dead center of the button cap 511 (especially with more curvature) and miss the troughs 510, and flatten to conform to the top of the button to create the characteristic contact patch.

As shown in each of FIGS. 9A and 9B, the panel 500, keys 501, and/or thinner region 311 are slightly suspended above the touchscreen, and when a key is pressed, the plastic deforms and reproduces a circular or oval finger contact patch. The full contact area may be larger than that shown; inasmuch as the software of the touchpanel may recognize fingers and reject styli and other small contacts, it may be more important to reproduce the expected capacitive signal (patch).

FIGS. 9C and 9D shows further alternative technique. In FIG. 9C, each key cap 511 is suspended atop or attached to a transparent dome switch 513 of compliant elastomer or sufficiently elastic plastic, which deforms to provide tactile feedback and may click as the button 511 is depressed. The material of the dome 513 need not be conductive, but must reproduce the expected capacitive profile of a finger F contract patch when stacked and depressed as shown. In FIG. 9D, the key caps 511 are affixed to and suspended by an elastomer sheet 515 that deforms. The user's finger F tends to strike top dead center of the button cap 511 (especially with more curvature) and localize more distinctly as the key 511 is pressed.

Alternative 1

A further variant would be substantially more rigid for the keyboard overlay panel, and more of a flip cover keyboard than a wrap keyboard. A rectangular panel would cover only the virtual keyboard space. Within the panel, a subpanel sheet, e.g., substantially 1 mm or thinner, includes dome keys. These keys match the position, size, and shape of the virtual keyboard keys. The subpanel may be opaque and formed from thin metal or rigid plastic in the manner of many slide out keyboards. It may be clear and flat, with each key having an indented border from the top side and a dome cavity in the underside. The subpanel may be bordered by a rigid plastic or metal frame. The frame may attach to the side support area, discussed above, of a housing for the entire phone. The attachment would be an arm or web connector. If the web attaching the side support area of the housing to the frame, panel, or subpanel is particularly flexible (e.g., as flexible as ½ mm thick silicone sheet), then it would permit sharp bending at the side support area as well as sharp bends to follow the contour of the phone edge. If the web were thicker or more rigid plastic such as nylon or pvc, or a thin metal sheet, and bent in a curve around the phone edge, an actual plastic or metal hinge extending along the side would permit the panel rectangle to flip from phone back to phone front.

Alternative 2

A very streamlined variation is a rectangular keyboard-shaped film with sufficient adhesion and re-adhesion to stick to the back of the phone while unused, but easily removed and restuck to the touchpanel, having electrical characteristics sufficient to activate the virtual keyboard buttons via a finger press and enough button outline (raised) and travel (not compression, actual key travel through air against bias) to “feel like” at least a dome-switch keyboard, preferably with enough detent bend in the upward bias to “click over” when pressed. If flat enough, this variant, could be made into business cards or promotional cards.

Alternative 3

In another alternative, the panel is roughly 20 thousands of an inch to 40 thousands of an inch or ½ to 1 mm thick (with raised keys), but thinner at the hinge (where hinge also means flexible joint). This variation opens the front panel (clamshell) like a book. A piano hinge (extended flexible joint) would extend along the side of the phone nearest the display area of the virtual keyboard. At the other end of the panel, a wrappable lock tab would secure the top of the panel to a connector or lock the side of the phone opposite the keyboard (top of the phone in the photo above).

A further variation of the book-style reduces the front panel size, and may include: a neoprene or black plastic housing/casing, a web at a side edge connected to a metal or otherwise stiff frame for a subpanel, and each button in a clear subpanel both domed in the center of the button (for tactile key response and key location) and recessed at the edges of the button from the subpanel face (to preserve contour). “Subpanel” means a panel smaller than the touchscreen of the phone. Such as rigid rectangular frame can readily fit into a receiving receptacle formed into the housing of the cover, on the back of the phone, surrounding the phone's own housing. In this position, the bottom of the keys are visible, but do not particularly disturb the contour of the phone. The frame can be provided with a finger or thumb tab to permit it to be readily extracted from the back receptacle or flipped front to back and vice versa.

Alternative 4

In the context of a tablet shaped telephone including no mechanical QWERTY keyboard of any kind, Alternative 4 is a flexible keyboard panel, made of sufficient amounts of elastomer or with sufficient flexibility flatten to and partially cover the portion of a capacitive touchscreen, particularly an iPhone style multitouch capacitive touchscreen. The panel flattens to and partially cover the portion of a capacitive touchscreen in the portion where a keyboard appears when typing applications are in use. The panel integrates with the form and lines of a casing, housing, sleeve, jacket used to house the phone and support the panel.

The panel does not obscure the typing area where letters appear. The panel includes button elements that cover each button and approximate the shape of each button in the on-screen virtual keyboard; are sufficiently raised from the surface to permit key travel in the manner of membrane keyboards, preferably with air space between the button and the touchscreen;are biased up by elastomer around the button rim to return after travelling down when pressed; and permits finger actuation of the button to inherently activate the corresponding area on the capacitive touch panel (when one presses the button, it does not actuate the virtual keyboard button until there is a tactile press and travel down to the touchscreen, whereupon the electrical connection, conductance, or capacitance from a finger via the button to the touchscreen activates the coordinates on the touchscreen panel and thereby the virtual keyboard button.

This is an “aftermarket’ addition to the basic phone. An example covers the entire touchscreen excepting a window where type appears as it is typed. The window can be a hole. In one example, the panel is roughly ½ to 1 mm thick (with raised keys). After the keyboard is locked in place over the panel, typing is done in two hands with both thumbs, blackberry style, and use usually would be limited to particularly lengthy missives or an email session of answering several emails in a row. For this reason, the wrap should take less than a second to secure in a stowed or use position. The panel may have enough button outline (raised) and travel (not compression, actual key travel through air against bias) to “feel like” at least a dome-switch keyboard, preferably with enough detent bend in the upward bias to “click over” when pressed. A portrait mode device would have its keyboard and window arranged for the portrait mode keyboard.

Alternative 5

For a touchscreen panel like the Blackberry Storm 2, which has four piezoelectric sensors in each corner to provide tactile feedback in the form of capacitive panel travel and/or clicking sounds and or feeling (via piezo actuation), an alternative embodiment would provide an elastomeric border around the keyboard panel 500 (to travel with the screen). Otherwise, the benefits in improving the localizing of a user's fingers by the “wall” approach or the “dome” approach are substantially similar. In this case, there is no particular need to include dome-switch capability.

Alternative 6

The rear clamshell 200 may be provided with a guide channel extending in the lengthwise direction, which receives a metal plate with a keyhole therein in the shape of a traditional “church key” bottle opener. The metal plate church key opener is slid with the thumb along the guide to a position extending beyond the top of the smart phone SP, where it is used to open bottles, then restored to a conforming position. The same structure, suitably dimensioned, can be used to store a credit-card pocket knife of the Swisscard™ type.

Alternative 7

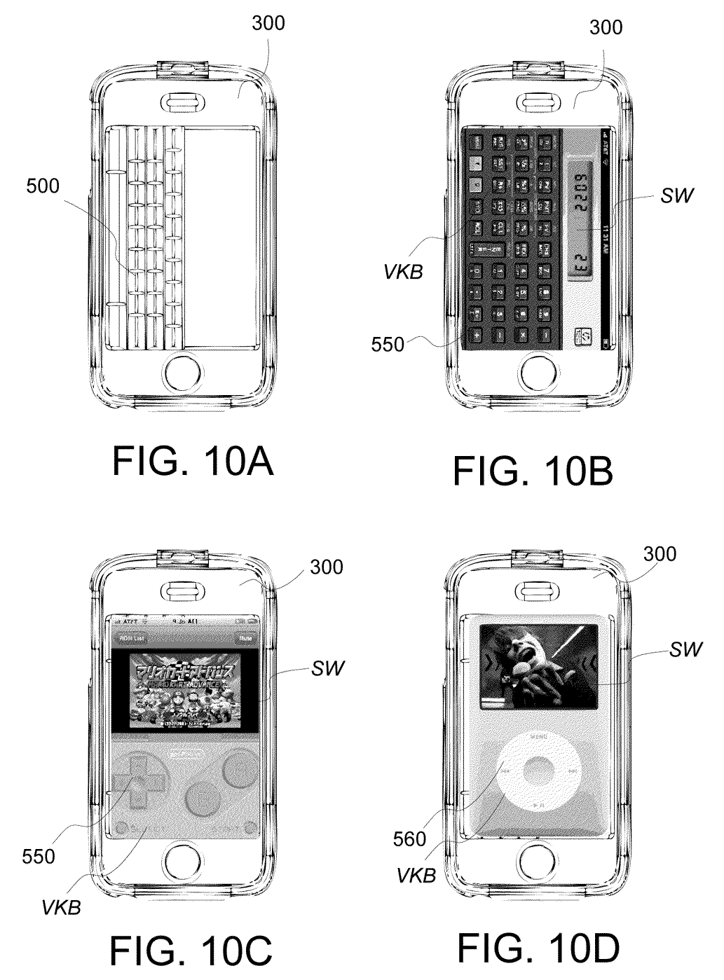

FIGS. 10A-10D show alternative overlays for virtual input interface elements, including a prose keyboard, a calculator keyboard, a handheld game console input panel, and one common MP3 player input panel.

FIG. 10A shows a keyboard overlay 100 and prose keyboard 500 discussed at length herein, away from the smartphone SP. In contrast FIG. 10B represents a calculator keyboard 550 for a financial calculator application (i.e., a virtual financial calculator replicating the functionality and appearance of a real world calculator, displayed and controlled as a software application targeted at the touchscreen), with keys arranged in a pattern matching the underlying application's graphical user interface representation of keys (VKB) and display area (SW). The key target forms of the overlay's calculator keys may be of identical or scaled physical structure to that disclosed herein. In this case, for example, an accountant may make use of the virtual financial calculator with frequency, and find the physical keyboard overlay to improve key response and use of the financial calculator application.

FIG. 10C represents a calculator keyboard 550 for a handheld game console input panel (i.e., a virtual handheld game console such as a Nintendo Gameboy, DS, or Playstation Portable, replicating the functionality and appearance of a real world handheld game console, displayed and controlled as a software application targeted at the touchscreen), with interface elements including keys arranged in a pattern matching the underlying application's graphical user interface representation of keys (VKB) and display area (SW). The key target forms of the overlay's buttons may be of identical or scaled physical structure to that disclosed herein. The directional pad (D-Pad) of such a device may simply have four key target forms, or may be more closely simulated (e.g., by providing a round disk or cross element of thin plastic capable of transmitting finger contract patches, supported by a central rocker or pivot, such that a larger air space is created underneath the four poles of the D-Pad, and each direction may be pressed down against resilient connection to the thin panel (under each D-Pad pole, or connecting the D-Pad element to the panel).

FIG. 10D represents common MP3 player input panel 560 (i.e., a virtual handheld MP3 player such as an Apple Corporation iPod Classic, replicating the functionality and appearance of a real world handheld MP3 player, displayed and controlled as a software application targeted at the touchscreen), with interface elements including a touch wheel arranged in a pattern matching the underlying application's graphical user interface representation of keys (VKB) and display area (SW). The key target forms of the overlay's keys may be of identical or scaled physical structure to that disclosed herein. The touch wheel may be closely simulated (e.g., by providing a round annular depression that guides the user's thumb for one handed operation).

FIGS. 10A-10D together show that the approach detailed herein for prose keyboards extends to other virtual keyboards and physical input mechanisms simulated by applications displaying virtual versions of such real world input elements. As discussed herein, the language “button” or “key” is considered to include buttons, keys, rocker buttons, “D-pad” elements, slider and wheel elements, in each of virtually displayed and physically overlayed key target forms.

### Conclusion

It should be noted that the present invention expressly contemplates combinations of features of each disclosed alternative. For example, the subpanel of alternative 3 may be included as a portion of the front clamshell as disclosed. Linking members or webs, as well as side walls and other rim elements, may be replaced with elastomeric or flexible elements as described.

The present disclosure gives as examples smartphones in the form of smoothed tablet without a mechanical keyboard, e.g. Apple Corporation iPhone, Research in Motion Blackberry Storm & Storm 2, Palm Pre, Google Android devices of similar form factor. The term “smartphone” and the tablet form also expressly describes similar devices that lack cell phone capability, but otherwise share electronics and operating system features and lack a physical or mechanical keyboard, such as the Apple Corporation iPod Touch, or similar devices of larger scale (e.g., B5 or A4 sized devices).

The present disclosure gives as examples a capacitive multitouch touchscreen. While there are particular synergies with this hardware with many features of the present embodiments as disclosed herein, alternative interaction modes (piezo actuation, resistive actuation) may also work with some embodiments described herein, and are not excluded from the contemplated invention.

What is claimed is:

1. An external cover for a monolithic tablet smartphone formed as a smoothed tablet with a flat touchscreen on a front surface thereof and a docking port at a bottom portion of a rounded peripheral side wall of the smoothed tablet, comprising:
a rear clamshell formed of deformable plastic material that receives and surrounds a rear surface and a portion of a peripheral side wall of the smoothed tablet, including:
a form-fitting rear surface that matches the shape of the rear of the rounded tablet,
a rim extending about the periphery of the form fitting rear surface to a height greater than ½ of the height of the peripheral side wall to deform and resiliently clip the rear clamshell to the smoothed tablet
a hinge blister located at the top of the rear surface, including a first hinge mechanism having a first degree of freedom;
a front clamshell that receives and surrounds the front surface of the smoothed tablet, including:
a form fitting front rim portion that matches the shape of a front portion of the peripheral side wall, to a height less than ½ of the height of the peripheral side wall, to be freely lifted and dropped on the front surface of the smoothed tablet
an arch shaped rim portion extending from the form fitting front rim portion, having an arch shaped cross section extending about substantially the periphery of the front clamshell;
a planar sheet, formed of dielectric plastic, that covers the entirety of the flat touchscreen and is joined to the arch shaped rim portion, and being formed in a shape and thickness that substantially transmits the shape of a capacitive finger contact patch through the planar sheet to the touchscreen,
a locking clip formed at a bottom portion of the second rim portion proximate the location of the docking port, that engages with a cavity in the docking port and is deformable to disengage the front clamshell from the smoothed tablet
a second hinge mechanism having a second degree of freedom; and
a substantially rigid linking member that forms a reversible wrapping linkage by connecting the first and second hinged mechanisms.

2. The external cover according to claim 1, wherein the planar sheet is transparent polycarbonate of substantially 20/1000 minimum thickness.

3. The external cover according to claim 1, wherein the planar sheet comprises, formed therein:
a landscape form keyboard shape formed in the polycarbonate planar sheet, including key target forms located in positions on the touchscreen indexed individually to corresponding keys of a virtual landscape keyboard displayed on the touchscreen underneath the polycarbonate planar sheet, such that letter and symbol indicia of the keyboard are displayed through the key target forms.

4. The external cover according to claim 3, including at least one key target form located in a positions on the touchscreen indexed to more than one corresponding key of more than one virtual landscape keyboard displayable on the touchscreen underneath the polycarbonate planar sheet, such that a same key target form extends across different letter and symbol indicia of different keyboards displayable through the key target form.

5. The external cover according to claim 3, wherein the key target form is an elongated channel-shaped cavity, having a minimum thickness substantially in the center thereof substantially transmits the shape of a capacitive finger contact patch through the planar sheet to the touchscreen, and walls surrounding the minimum thickness that attenuate the edges of the shape of a capacitive contact patch through the planar sheet to the touch screen.

6. The external cover according to claim 3, wherein the key target form is a key shape having a minimum thickness substantially in the center thereof that substantially transmits the shape of a capacitive finger contact patch through the key shape, surrounded by a partial air gap that attenuate the edges of the shape of a capacitive contact patch through the planar sheet to the touch screen.

7. The external cover according to claim 6, wherein a snap dome mechanism intervenes between the key shape and substantially transmits the shape of a capacitive finger contact patch therethrough.

8. An external cover for a monolithic tablet smartphone formed as a smoothed tablet with a flat multitouch touchscreen on a front surface thereof and a docking port at a bottom portion of a rounded peripheral side wall of the smoothed tablet, comprising:
a flexible keyboard panel, with sufficient flexibility to flatten to and partially cover the multitouch capacitive touchscreen, that flattens to and partially covers the portion of the touchscreen in the portion where a keyboard appears when typing applications are in use, the panel integrates with the form of a sleeve used to house the phone and support the panel, wherein the panel does not obscure a typing area of the touchscreen where letters appear, the panel including:
button elements that cover each button and approximate the shape of each button in the on-screen virtual keyboard, the button elements being sufficiently raised from the surface to permit key travel in the manner of membrane keyboards, biased up by elastomer to return after travelling down when pressed, finger actuation of the buttons activating key presses of keys of a virtual keyboard of the capacitive touch panel when there is a tactile press and travel down to the touchscreen, activating coordinates on the touchscreen panel and thereby the virtual keyboard button, wherein
the cover covers the entire touchscreen excepting a window where type appears as it is typed, and after keyboard in place over the panel, typing is done in two hands with both thumbs on a dome-switch keyboard, preferably with enough detent bend in the upward bias to click over when pressed.

9. A keyboard overlay for a monolithic tablet smartphone formed as a smoothed tablet with a flat touchscreen on a front surface thereof, comprising:
a front clamshell that receives and surrounds the front surface of the smoothed tablet, including, including a form fitting front rim portion that matches the shape of a front portion of the peripheral side wall and is readily lifted and placed on the front surface of the smoothed tablet,
a planar sheet, formed of dielectric plastic, that covers the entirety of the flat touchscreen and is joined to the form fitting front rim portion, and formed in a shape and thickness that substantially transmits the shape of a capacitive finger contact patch through the planar sheet to the touchscreen,
a landscape form keyboard shape formed in the planar sheet, including key target forms located in positions on the touchscreen indexed individually to corresponding keys of a virtual landscape keyboard displayed on the touchscreen underneath the polycarbonate planar sheet, such that letter and symbol indicia of the keyboard are displayed through the key target forms, each key target form being an elongated channel-shaped cavity, having a minimum thickness substantially in the center thereof substantially transmits the shape of a capacitive finger contact patch through the planar sheet to the touchscreen, and walls surrounding the minimum thickness that attenuate the edges of the shape of a capacitive contact patch through the planar sheet to the touch screen, and including at least one key target form located in a positions on the touchscreen indexed to more than one corresponding key of more than one virtual landscape keyboard displayable on the touchscreen underneath the polycarbonate planar sheet, such that a same key target form extends across different letter and symbol indicia of different keyboards displayable through the key target form.
